(19) United States
(12) Patent Application Publication
(10) Pub. No.: US 2018/0282211 A1
(43) Pub. Date: Oct. 4, 2018

(54) COVERING READINESS INDICATOR

(71) Applicant: Uzin Utz AG, Ulm (DE)

(72) Inventors: Markus Wilde, Ulm (DE); Markus GRETZ, Ulm (DE); Johannis TSALOS, Ulm (DE)

(21) Appl. No.: 15/945,019

(22) Filed: Apr. 4, 2018

(30) Foreign Application Priority Data
Apr. 4, 2017 (EP) 17164720.9

(51) Int. Cl. C04B 16/00; C04B 28/02; C04B 28/14; C09K 11/02; C09K 11/06

(52) U.S. Cl. CPC C04B 16/00; C04B 28/02; C04B 2103/0097; C09K 11/025; C09K 11/06; C04B 28/14

(57) ABSTRACT

The present invention relates to floor levelling compositions which can be mixed with water and comprise fluorescein or a derivative thereof. The present invention further relates to the use of fluorescein or fluorescein derivatives as indicator for the readiness for being covered of a floor levelling composition mixed with water.

### CROSS REFERENCE TO RELATED APPLICATION

The present application claims priority to European Patent Application Serial No. 17164720.9, filed Apr. 4, 2017, the content of which is incorporated by reference in its entirety.

### TECHNICAL FIELD

The present invention relates to floor levelling compositions which can be mixed with water and comprise fluorescein or a derivative thereof. The present invention further relates to the use of fluorescein or fluorescein derivatives as indicator for the readiness for being covered of a floor levelling composition mixed with water.

### BACKGROUND

The laying of floor coverings such as PVC coverings, rubber coverings and textile coverings makes it necessary for the substrate to meet particular requirements. Levelling/trowelling compositions are used for levelling out unevennesses in the floor or as-laid floor. They serve, inter alia, for levelling of the substrate or ensure a constant absorption capability of the substrate. The absorption capability is of great importance in particular for subsequent adhesive bonding of floor coverings using aqueous adhesive systems (e.g. dispersion adhesives).

Levelling compositions are frequently supplied as one-component dry mortars mixed in the factory. One-component dry mortar systems are formulated powder products which are mixed with water and thereby attain a workable consistency before application.

Mineral materials are predominantly used as binders in levelling compositions. On being brought into contact with water, these react in dissolution and crystallization processes to form hydration products which are responsible for the strength of building materials. As binders in levelling compositions, use is made of, inter alia, cement-type binders (Portland cement, composite cements, high-alumina cements), limes or gypsum (calcium sulphate binder) in various modifications (e.g. anhydrite, hemihydrate). Combinations of different mineral binders are frequently used in levelling compositions. Apart from mineral binders, the levelling compositions described contain fillers (e.g. sand, ground limestone), polymers (e.g. redispersible dispersion powders) and also organic and inorganic additives for controlling the processing and product properties.

Ensuring rapid progress of building work is a key requirement which levelling compositions have to meet. This means functional, damage-free laying of floor coverings on the abovementioned building products. To obtain functional, damage-free laying of floor coverings, the substrate has to have a sufficiently low residual moisture content. This applies particularly in the laying of vapour-impermeable coverings (e.g. PVC, rubber). After laying of such coverings, water which is not chemically and/or physically bound can escape from the substrate only extremely slowly and during its continuing presence lead to damage to the substrate and to a reduction in the technical functionality through to complete failure of the adhesive bond (e.g. bubble formation, detachments). The readiness of a levelling composition to be covered corresponds to the time between application thereof and the point in time after which functional adhesive bonding of floor coverings is possible. When the readiness for covering has been attained, a sufficiently low residual moisture content is present or water introduced by application of the adhesive can be compensated for so that no damage to the adhesive bond occurs.

In order to attain the processing consistency, dry mortar systems are mixed with an excess of mixing water. This means that there is more water available than is required by the binder system for setting and for forming the hydration products. Excess water therefore has to be given off by evaporation via the surface to the surroundings and/or be absorbed by the substrate.

Cement-type products differ significantly in terms of their drying time, namely the time until they are ready for covering, from gypsum-based products, but there are also differences within the group of cement-type binder systems and within the group of gypsum-based binder systems depending on binder content and binder composition; thus, for example, there are quick-setting cement products which are ready to cover after one hour (e.g. Uzin NC 172 BiTurbo, Uzin Utz AG, Ulm, Germany), but also cement-type and gypsum-based products which are ready to cover only after 24 hours.

It is therefore not easy for the layer to recognize when a levelling composition is dry enough for further laying work. This depends substantially on the type and composition of the binder.

In order to indicate the readiness for covering of levelling compositions precisely, it would be desirable to have a system which indicates the readiness for covering simply and without complicated analytical systems. A person skilled in the art usually relies on the technical product data sheets of the manufacturers, but in these the times indicated are generally based only on standard conditions (e.g. 20° C., 65% relative atmospheric humidity), and so differences can arise in practical use under different climatic conditions.

There is, for example, already a cement-based product which indicates the readiness for covering by means of a particular colour change, namely the adhesive slurry Ardex A 18 (Ardex GmbH, Witten, Germany). However, this adhesive slurry is provided with pigment and after drying changes only from dark green to light green.

Furthermore, WO 2008/003672 A1 describes a render or a powder coating in which a colour change is generated by means of phenolphthalein and/or thymolphthalein on complete drying. In this system, the colour change is from pink-violet in the wet state to white on complete drying.

There has hitherto not been a genuine colour change when cement-type and gypsum-based levelling compositions are ready to cover.

It is therefore an object of the invention to provide a levelling composition which indicates, in a simple and reliable way, that it is ready to cover.

### BRIEF DESCRIPTION OF THE DRAWINGS

The appended drawings are intended to illustrate embodiments of the presently disclosed subject matter and to impart a further understanding thereof. Together with the description, they serve to explain concepts and principles of the presently disclosed subject matter. Other embodiments and many of the stated advantages are apparent from the drawings. The elements in the drawings are not necessarily shown in scale with one another. Identical, functionally identical and actively identical elements, features and components are provided in each case with the same reference symbols in the figures of the drawings, unless otherwise stated.

FIG. 1 shows the structure of fluorescein as a function of the pH. Here, the stable carboxylic acid form (red crystals, left-hand part of the figure) goes over in an alkaline medium into the more unstable yellowish spirolactone form (right-hand part of the figure) as a result of deprotonation (middle part of the figure). The change is reversible.

FIG. 2 shows a comparison of the readiness for covering/drying for the commercially available product Uzin NC 172 BiTurbo. t₀ denotes the point in time at which the test commences, i.e. after application of the levelling composition to the substrate. t₁ denotes the point in time of the experimentally determined readiness for covering (see above-described method), t₂ denotes the point in time at which drying is complete.

FIG. 3 shows a comparison of the readiness for covering/drying for the commercially available product Uzin NC 112 Turbo. t₀ denotes the point in time at which the test commences, i.e. after application of the levelling composition to the substrate. t₁ denotes the point in time of the experimentally determined readiness for covering (see above-described method), t₂ denotes the point in time at which drying is complete.

### DETAILED DESCRIPTION

This object is achieved by a levelling composition, preferably floor levelling composition, which can be mixed with water and comprises fluorescein or a derivative thereof.

As a result of the use of fluorescein, for example in a gypsum levelling composition, it has surprisingly been found that when readiness for covering has been attained, a colour change in the composition from greenish to reddish occurs. This functions over a wide layer thickness range.

Furthermore, for example, a cement-type levelling composition was admixed with fluorescein, made up with water and applied by trowel/spatula. The levelling composition made up with water had a grey-green colour. After some time, the colour then changed to grey with a red cast and correctly indicated readiness for covering.

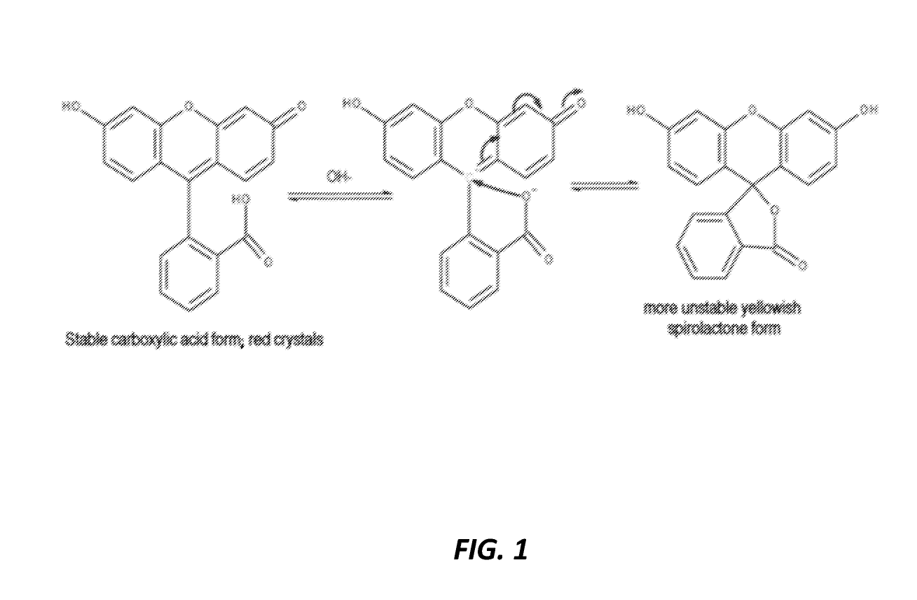

Without wishing to be restricted to a particular mechanism, the observed colour change is presumably attributable to fluorescein being present in the relatively unstable yellowish spirolactone form in the (usually alkaline) levelling composition which has been mixed with water (see FIG. 1). As a result of the curing of the levelling composition and the drying which occurs, the pH decreases and the fluorescein goes over into the more stable red carboxylic acid form. For this reason, when fluorescein is used in levelling compositions having an alkaline pH, the region of readiness for covering is indicated by a colour change from greenish to reddish.

The invention therefore provides a levelling composition which can be mixed with water and comprises fluorescein or a derivative thereof.

The derivative of fluorescein can be eosin and/or a salt of fluorescein, for example the potassium salt or the sodium salt of fluorescein (uranin). Eosin can be eosin B or eosin Y. Fluorescein or the above-described derivatives all have a very similar chemical structure and have a carboxylic acid group at a comparable position within the molecule. The carboxylic acid group is deprotonated in the alkaline range, which as a result of a stearic rearrangement within the molecule leads to a change in the absorption spectrum of the molecule. For this reason, these molecules have a different colour as a function of the pH and can be used in the levelling compositions according to the invention.

In a further embodiment, mixtures of fluorescein, salts thereof, eosin B or eosin Y are also used in the levelling compositions of the invention. Here, the mixture can contain at least 2, 3, 4 or 5 components selected from the group consisting of fluorescein, potassium salt of fluorescein, sodium salt of fluorescein, eosin B or eosin Y. The individual components in the mixture can be present in equal or unequal mass or molar ratios.

In a preferred embodiment, the fluorescein or fluorescein derivative, or a mixture thereof, is present in an amount sufficient for determining the readiness for covering, preferably in an amount of 0.001-5.0% by weight based on the total weight of the dry composition. In a preferred embodiment, the fluorescein or fluorescein derivative, or a mixture thereof, is present in an amount of 0.006-1.0% by weight, preferably 0.01-0.5% by weight, based on the total weight of the dry composition.

Levelling compositions are generally obtainable in powder form and can be made up/mixed with water to give the ready-to-use composition.

The levelling compositions can contain mineral binders, fillers (preferably sand and/or ground limestone), optionally polymers (preferably redispersible dispersion powders) and also organic and/or inorganic additives which are suitable for controlling the processing and product properties.

In a further preferred embodiment, the levelling composition which can be made up with water is a cement-based or calcium sulphate-based levelling composition.

Suitable cement-based or calcium sulphate-based levelling compositions are known from the prior art (e.g. UZIN NC 170 LevelStar or UZIN NC 112 Turbo, both from Uzin Utz AG, Ulm, Germany).

In one embodiment, the levelling composition which can be mixed with water is a calcium sulphate-based levelling composition which can contain cement. In a preferred embodiment, the levelling composition which can be mixed with water is a calcium sulphate-based levelling composition as is described in WO 2016/142365 A1 but additionally contains fluorescein (derivatives thereof, or a mixture thereof). This levelling composition comprises, by way of example:
a) from 20 to 80% by weight of at least one binder based on calcium sulphate;
b) from 1 to 15% by weight of at least one ettringite former;
c) from 0.01 to 5% by weight of at least one activator; and
d) from 8 to 60% by weight of at least one filler;
e) from 0.1 to 10% by weight of at least one redispersible dispersion powder;
f) fluorescein, derivatives thereof, or a mixture thereof, in an amount of 0.001-5.0% by weight,
   in each case based on the total amount of the formulation, where the amounts add up to 100% by weight.

In a preferred embodiment of the calcium sulphate-based levelling composition of the invention, the binder is selected from among calcium sulphate hemihydrate (calcium sulphate α-hemihydrate and/or calcium sulphate β-hemihydrate), calcium sulphate anhydrite, calcium sulphate dihydrate and mixtures of two or more thereof. The binder is preferably calcium sulphate hemihydrate. The binder is present in an amount of from 20 to 80% by weight, based on the total mass of the formulation, in the calcium sulphate-based levelling composition of the invention, with particular preference being given to a content of from 35 to 60% by weight, and very particular preference to a content of from 40 to 55% by weight, in particular from 41 to 55% by weight.

A further constituent of the calcium sulphate-based levelling composition of the invention is at least one ettringite former. The ettringite former is present in an amount of from 1 to 15% by weight, based on the total mass of the formulation, in the formulation. Preference is given to a content of ettringite former of from 3 to 10% by weight, in particular from 3 to 8% by weight. The ettringite former is preferably selected from among calcium sulphoaluminate cement (CSA cement), sodium aluminate, high-alumina cement, aluminium sulphate and mixtures thereof. Very particular preference is given to using calcium sulphoaluminate cement, high-alumina cement or mixtures thereof as ettringite former.

Preference is given to a high-alumina cement having the chemical composition 35-71% by weight of Al₂O₃, 27-40% by weight of CaO, 0.5-5% by weight of SiO₂ and 0.1-20% by weight of Fe₂O₃ or CSA cement having the chemical composition 27-31% by weight of Al₂O₃, 36-41% by weight of CaO, 2-7% by weight of SiO₂, <1.5% by weight of Fe₂O₃, 12-16% by weight of SO₃ and <5% by weight of MgO.

Ettringite is a mineral from the class of water-containing sulphates with foreign anions. It crystallizes with the chemical composition Ca₆Al₂[(OH)₁₂|(SO₄)₃].26 H₂O and develops usually well-formed, prismatic or acicular crystals. According to the notation which is more customary in building chemistry, the oxidic formula is: 3CaO.Al₂O₃.3CaSO₄.32H₂O. In the context of the present invention, ettringite formation is the formation of ettringite from the constituents a) and b) of the formulation according to the invention. The formation of ettringite from the abovementioned components a) and b) represents an advantageous possible way of binding water. The proportion of calcium sulphate binder and ettringite former in the total formulation is preferably about 40-60% by weight.

The addition of an ettringite former to the calcium sulphate-based levelling composition of the invention makes it possible to ensure, by means of the binding of water as indicated above, rapid drying and setting of the applied levelling compositions.

The calcium sulphate-based levelling composition of the invention additionally contains at least one activator which is preferably selected from among Portland cement, calcium hydroxide, sodium hydroxide, potassium hydroxide, alkali metal water glasses and mixtures thereof. Particular preference is given to Portland cement or calcium hydroxide or mixtures thereof.

The activator or activators are added in order to control the pH of the calcium sulphate-based levelling composition, preferably to increase it. For example, an amount of activator which is sufficient to set a pH of from 8 to 14 is added to the calcium sulphate-based levelling composition. Particular preference is given to a pH of from 9 to 13 being able to be set by the addition of the activator. The setting of the pH to a value of from 9 to 12, in particular from 10 to 11, by the addition of activator has the effect that ettringite formation in the calcium sulphate-based levelling composition occurs at a pH in the stated range. Thus, ettringite formation advantageously does not occur spontaneously but in a manner controlled by the addition of activator.

The activator is present in the calcium sulphate-based levelling composition in an amount of from 0.01 to 5% by weight, based on the total mass of the levelling composition. The activator is preferably present in an amount of from 0.1 to 2% by weight, based on the total mass of the formulation, in the formulation.

In addition to the components a) to c), fillers are present in an amount of from 8 to 60% by weight, based on the total mass of the formulation, in the calcium sulphate-based levelling composition of the invention. The amount of fillers is preferably from 30 to 60% by weight, in particular from 35 to 55% by weight, based on the total mass of the formulation. Examples of fillers are silica sands, limestone and ground limestones, dolomite, talc, mica and also lightweight fillers such as expanded glass granules or expanded clays. In addition, latently hydraulic constituents such as pozzolanas, fly ashes or blast furnace slag are also suitable. The average particle size of the filler is preferably from 0.001 to 10 mm, in particular from 0.005 to 8 mm. Preferred fillers are sand or ground limestone and mixtures thereof.

In addition to the components a) to d), redispersible dispersion powders are present in an amount of from 0.1 to 10% by weight, based on the total mass of the formulation, in the calcium sulphate-based levelling composition of the invention. The amount of redispersible dispersion powder is preferably from 0.5 to 10% by weight, in particular from 1.0 to 10% by weight, based on the total mass of the formulation.

Redispersible dispersion powders can be polymers or copolymers based on vinylaromatics such as styrene, vinyl esters of C₁-C₁₅-alkylcarboxylic acids, dienes, esters of (meth)acrylic acid with C₁-C₁₂-alkanols, vinyl halides and/or olefins. Preference is given to vinyl esters of C₁-C₁₅-alkylcarboxylic acids, copolymers of vinyl esters of C₁-C₁₅-alkylcarboxylic acids with olefins or copolymers of esters of (meth)acrylic acid with C₁-C₁₂-alkanols with styrene. Examples which may be mentioned are ethylene-vinyl acetate copolymers, ethylene-vinyl versatate copolymers or styrene acrylates.

Preference is given to using a polymer or copolymer having a minimum film formation temperature (MFT) in the range from about −5° C. to about +10° C. as redispersible dispersion powder. In a preferred embodiment, the calcium sulphate-based levelling composition additionally comprises at least one additive in an amount of from 0.01 to 7% by weight, preferably from 0.1 to 5% by weight, based on the total mass of the formulation. The additive is preferably selected from among plasticizers, setting retarders, setting accelerators, thickeners, stabilizers, polymer fibres, antifoams, air pore formers, dispersants/wetting agents, hydrophobicizing agents and mixtures thereof.

Plasticizers are, for example, casein, melamine-formaldehyde condensates or comb polymers based on poly(meth)acrylic acid with polyethylene oxide side chains (PCEs, polycarboxylate ethers). Examples of thickeners are mineral sheet silicates such as bentonite or talc. Stabilizers can be organic stabilizers, for example polysaccharides such as starch ethers, guar gum, xanthan gum and cellulose ethers and modified cellulose ethers, for example methyl cellulose, ethyl cellulose, propyl cellulose and methyl ethyl cellulose, hydroxyalkyl celluloses such as hydroxyethyl cellulose (HEC), hydroxypropyl cellulose (HPC) and hydroxyethyl hydroxypropyl cellulose, alkyl hydroxyalkyl celluloses such as methyl hydroxyethyl cellulose (MHEC), methyl hydroxypropyl cellulose (MHPC) and propyl hydroxypropyl cellulose, or polycarboxylic acids such as polyacrylic acid or polyvinyl alcohols. Setting retarders are, for example, fruit acids (tartaric acid or citric acid), phosphates, polyphosphates, alkali metal gluconates, saccharides or alkali metal tartrates. Suitable setting accelerators are, for example, alkali metal carbonates, sodium sulphate, potassium sulphate or calcium sulphate dihydrate. Examples of polymer fibres are polyolefin fibres having a length of from 0.1 to 1 mm, in particular polypropylene fibres. Further examples are polyacrylonitrile fibres. Examples of antifoams are modified siloxanes on inorganic support materials. Hydrophobicizing additives are, for example, salts of long-chain fatty acids or organosilicon compounds.

Finally, the calcium sulphate-based levelling composition contains fluorescein, derivatives thereof or a mixture thereof in an amount of 0.001-5.0% by weight.

The calcium sulphate-based levelling compositions of the invention are produced by successive mixing of the constituents in any order or by simultaneous mixing in a mixing apparatus customary for these purposes.

In another embodiment, the floor levelling composition which can be mixed with water is a cement-based levelling composition as is described in WO 2008/003672 A1. WO 2008/003672 A1 relates to levelling compositions which contain Portland cement, fillers or pigments as essential constituents. For example, cement-based levelling compositions with cement as main binder are described. The cement-based levelling compositions contain, as binder component, a mixture of aluminate cement (from 20 to 40% by weight, based on the total levelling composition) and a source of reactive sulphates (e.g. calcium sulphate) in an amount of from 2 to 15% by weight, based on the total levelling composition. The levelling compositions of the invention are produced by successive mixing of the constituents in any order or by simultaneous mixing in a mixing apparatus customary for these purposes.

In a further preferred embodiment, the levelling composition which has been made up with water and is ready to use has an alkaline pH in the range of pH 8-14. The ready-to-use composition preferably has an alkaline pH in the range of pH 9-13, pH 9-12 or pH 10-11.

The pH of the floor levelling composition which can be made up with water can be determined by any suitable method for measuring the pH of levelling compositions. The determination of the pH is carried out by a method based on the standard EN 13454-2:2003, point 4.1. This standard relates to gypsum-based levelling compositions but can also be applied analogously to cement-type products.

According to the standard EN 13454-2:2003, 1 part by mass of the pulverulent levelling composition which can be made up with water is dissolved in 10 parts of deionized or distilled water. The solution obtained is stirred for 5 minutes and the pH is then read off to a precision of 0.5 using a pH measuring instrument or a pH paper. As pH measuring instrument, it is possible here to use, for example, the Knick laboratory pH meter 766. As pH indicator paper, it is possible to employ Merck Millipore pH indicator paper Universal indicator or Merck Millipore MColorpHast® pH indicator strips pH 0-14.

The levelling composition which has been made up with water can contain water in any suitable ratio. In particular, the levelling composition which has been made up with water can comprise water in an amount of 10-60% by weight, 15-50% or 20-40% based on the total weight of the dry composition.

A further embodiment is directed to the use of fluorescein, fluorescein derivatives or a mixture thereof as indicator for the readiness of a levelling composition which has been made up with water for being covered.

A further embodiment is directed to a method of determining the readiness for covering of a levelling composition according to the invention which has been applied to a substrate, comprising the steps:
a) provision of a levelling composition, preferably floor levelling composition, which can be mixed with water and water;
b) mixing of the levelling composition which can be mixed with water and water in a suitable ratio;
c) application and distribution, in particular uniform distribution, of the levelling composition on the substrate; with a colour change of the levelling composition indicating the readiness for covering of the levelling composition distributed on the substrate.

In a further embodiment of the method, a colour change from a greenish colour to a reddish colour, in particular a colour change from a greenish yellow colour to a salmon colour or from a greyish green colour to a greyish red colour, occurs when readiness for covering has been attained.

In a further embodiment of the method, the layer thickness of the levelling composition applied to the substrate is about 1-10 mm, 2-9 mm, 3-8 mm, 4-7 mm or 5-6 mm.

In another embodiment of the method, the method is preferably, in step c), carried out at 5′-25° C., preferably at about 20° C.

The readiness for covering of a levelling compound corresponds to the period of time between application of the levelling composition and the point in time after which functional adhesive bonding of coverings, preferably floor coverings, is possible. In general, peeling values of greater than 0.6 N/mm after 24 hours after adhesive bonding are necessary for functional, damage-free adhesive bonding. Furthermore, these values should increase continuously and preferably be at least 1 N/mm (after 4 days after adhesive bonding).

According to this definition, the levelling composition is ready to cover when a peeling value of at least 0.6 N/mm (e.g. 0.7 N/mm, 0.8 N/mm or 0.9 N/mm) is reached 24 hours after adhesive bonding and a peeling value of at least 1 N/mm (e.g. 1.1 N/mm or 1.2 N/mm) is achieved after 96 hours after adhesive bonding. If the adhesive is applied before the levelling composition is ready to cover, the abovementioned values are not attained.

To assess the readiness for covering, the levelling compositions are applied in a layer thickness of, for example, 3 mm. Here, for example, the following procedure can be selected: A concrete substrate which has been pretreated with a water vapour-inhibiting 1-component rapid primer (e.g. UZIN PE 414 Turbo) and a dispersion-based bonding agent (e.g. Uzin PE 280) for the subsequent levelling operation is selected as substrate. For example, a concrete slab (e.g. 40 cm×40 cm) is provided. The application of the primer can be carried out in the following steps: the slab is firstly pretreated with, for example, 250-350 g/m² of the 1-component water vapour-inhibiting rapid primer. Application of primer can be carried out in two layers in a crosswise manner, with the drying time in each case being able to be 2 hours. A dispersion primer (e.g. Uzin PE 280), which serves as bonding agent for the subsequent levelling operation, can be applied thereto. The drying time can be about 1 hour.

The levelling composition which has been made up with water is then applied in a layer thickness of about 2-4 mm, preferably 2.5 mm or 3 mm, to the concrete slab which has been pretreated as described above. The drying time of the levelling composition can vary in the range from 6 to 26 hours.

Relatively vapour-impermeable floor coverings are subsequently adhesively bonded on. For the adhesive bonding of PVC (e.g. Armstrong DLW Royal), for example, a dispersion-based pressure-sensitive adhesive (e.g. UZIN KE 2000 S) is applied in an amount of about 300 g/m², e.g. by means of a trowel. Rubber coverings (e.g. Nora Noraplan Mega) are, for example, adhesively bonded using a wet bed dispersion adhesive (e.g. UZIN KE 66).

Subsequently, strips of covering (width: 5×25 cm) are peeled off from the substrate by means of a spring balance at various times after adhesive bonding and the peeling values (in N/mm) are thus determined.

The determination of the peeling value is carried out by a method based on the standard EN1372:2015 “Test method for adhesives for floor and wall coverings. Peel test”. To simplify the method, a spring balance is used to peel off the floor coverings manually instead of the roller shear device (automated testing machine) provided for in the standard.

The peeling force is then assessed at various points in time, e.g. 4, 6, 8, 10, 12, 14, 16, 20, 24 or from 26 to 96 hours after adhesive bonding. Here, one or more strips of covering were pulled off by means of a force meter (e.g. a spring balance) at each measuring point.

If, for example, strips of covering are adhesively bonded to the levelling composition on the concrete substrate after a drying time of, for example, 4 hours and a peeling value of 0.5 N/mm is attained after 24 hours, this would mean that the readiness for covering had not yet been attained at the point in time of adhesive bonding.

### EXAMPLES

### A Testing of Various Levelling Compositions (pH-Dependence, With/Without Fluorescein)

The following levelling compositions were tested. Example 1 represents a gypsum levelling composition with fluorescein, Example 2 represents a cement-based levelling composition with fluorescein, Comparative Example 1 represents a gypsum levelling composition with fluorescein and Comparative Example 2 represents a cement-containing adhesive slurry without fluorescein but with a green pigment or dye.

EXAMPLE 1: quickly covering-ready gypsum levelling composition (Uzin NC 112 Turbo) with pH>10 and with 0.025% by weight of fluorescein, based on the total weight of the dry composition, made up with 19% by weight of water based on the total weight of the dry composition.

EXAMPLE 2: NC 170 LevelStar with 0.025% by weight of fluorescein based on the total weight of the dry composition, made up with 26% by weight of water based on the total weight of the dry composition.

Comparative Example 1: Commercially available levelling composition based on calcium sulphate (Uzin NC 110) with 0.025% of fluorescein based on the total weight of the dry composition, made up with 24% by weight of water based on the total weight of the dry composition.

Comparative Example 2: Ardex A18 without fluorescein, made up with 23% by weight of water based on the dry weight of the dry composition.

To assess the readiness for covering, the abovementioned procedure was selected: levelling compositions were applied in a layer thickness of about 3 mm. A concrete substrate which had been pretreated with a water vapour-inhibiting 1-component rapid primer (UZIN PE 414 Turbo, Uzin Utz AG, Ulm, Germany) and a dispersion-based bonding agent (Uzin PE 280, Uzin Utz AG, Ulm, Germany) was selected as substrate.

As described above, the readiness for covering of a substrate corresponds to the period of time between application of the levelling composition and the point in time after which functional adhesive bonding of floor coverings is possible. In general, peeling values of greater than 0.6 N/mm after 24 hours after adhesive bonding are necessary for functional, damage-free adhesive bonding to the levelling composition. Furthermore, these values should increase continuously and preferably be at least 1 N/mm (after 4 days after adhesive bonding).

### Results

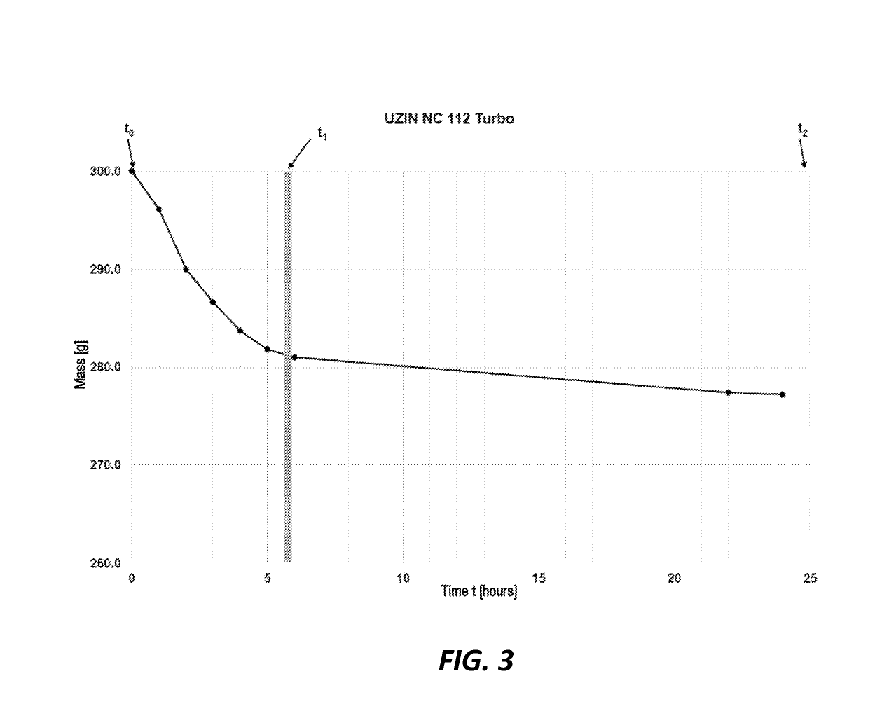

It was surprisingly found that a colour change from greenish yellow to salmon occurs in the case of the gypsum levelling composition NC 112 Turbo with addition of fluorescein in the region of the readiness for covering of 6 hours determined in previous tests (Table 1, Example 1a; FIG. 3). The temperature/relative atmospheric humidity here was 20° C./about 65%. This functions over the entire coating thickness range of 1-10 mm; at lower temperatures (Table 1, Example 1b), a colour change is observed at a later point in time (temperature 10° C., relative atmospheric humidity about 80%). Comparative Example 1 (Table 1, Uzin NC 110) does not display such a colour change, which is attributable to the neutral pH of the composition.

TABLE 1

| | | Colour at the time of | Colour 6 hours after | Colour 16 hours after | Colour 26 hours after |
|---|---|---|---|---|---|
| | Temperature/relative | application of the | application of the | application of the | application of the |
| Compositions | atmospheric humidity | levelling compositions | levelling compositions | levelling compositions | levelling compositions |
| Example 1a | 20° C./about 65% | Greenish yellow | Salmon | Salmon | Salmon |
| Uzin NC 112 | | | (readiness for | | |
| Turbo | | | covering attained) | | |
| with | | | | | |
| fluorescein | | | | | |
| Example 1b | 10° C./about 80% | Greenish yellow | Greenish yellow | Salmon | Salmon |
| Uzin NC 112 | | | | (readiness for covering | |
| Turbo | | | | attained) | |
| with | | | | | |
| fluorescein | | | | | |
| Comparative | 20° C./about 65% | Greenish yellow | Greenish yellow | Greenish yellow | Greenish yellow |
| Example 1 | | | | | (readiness for covering |
| Uzin NC 110 | | | | | attained) |
| with | | | | | |
| fluorescein | | | | | |

TABLE 2

| | Temperature/ | Colour at the time | Colour 6 hours | Colour 16 hours | Colour 26 hours |
|---|---|---|---|---|---|
| | relative | of application | after application | after application | after application |
| | atmospheric | of the levelling | of the levelling | of the levelling | of the levelling |
| Compositions | humidity | compositions | compositions | compositions | compositions |
| Example 2 | 20° C./about 65% | Greyish green | Greyish green | Greyish red | Greyish red |
| Uzin NC 170 LevelStar | | | | (readiness for | |
| with fluorescein | | | | covering attained) | |
| Comparative | 20° C. /about 65% | Dark green | Dark green | Light green | Light green |
| Example 2 | | | | | |
| Ardex A18 | | | | | |

In addition, a cement-containing product (Uzin NC 170 LevelStar) was admixed with fluorescein, made up with water and applied by trowel (Table 2, Example 2). After application of the levelling composition, the product had a greyish green colour which changed to greyish red after about 16 hours. The readiness for covering was found to be about 16 hours according to the above-described method, which likewise agrees with the colour change.

It is thus shown that the colour change observed can be employed for determining the readiness for covering both for levelling compositions based on gypsum and also those based on cement. In particular, the colour change also occurs when application is carried out at conditions other than standard conditions at lower temperature and increased atmospheric humidity.

In Comparative Example 2 (Table 2, Ardex A18; no fluorescein), no genuine colour change was observed, merely a slight alteration of colour from dark green to light green.

### B Distinction Between Degree of Drying and Readiness for Covering

### Uzin NC 172 BiTurbo

In this example, the commercially available composition Uzin NC 172 BiTurbo was firstly examined. This is a cement-containing levelling composition comprising mineral aggregates, polyvinyl acetate copolymers, high-performance plasticizer and additives, to which 0.025% by weight of fluorescein based on the total weight of the dry composition had been added.

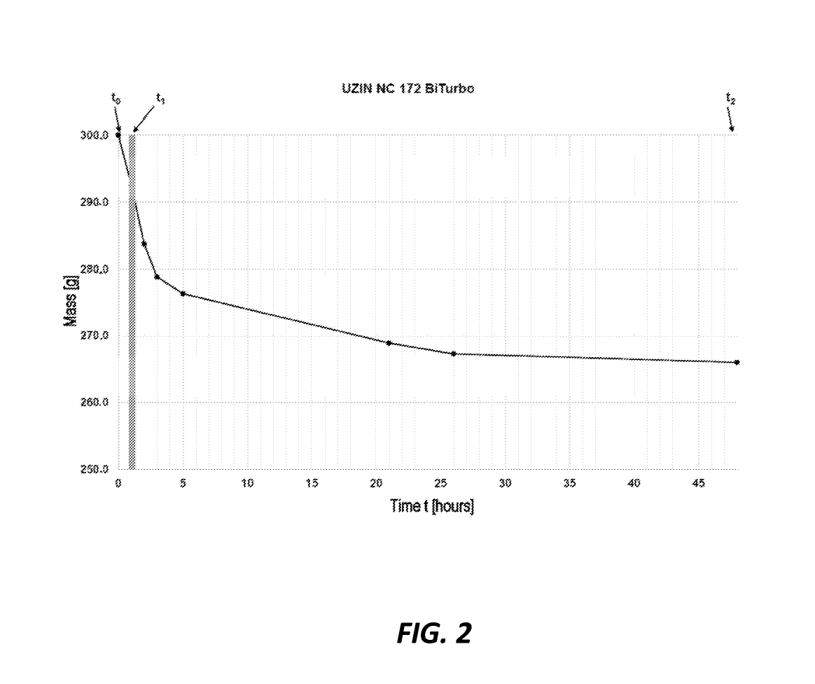

The loss of water from the levelling composition made up with water and applied to the substrate was examined as a function of time (see also FIG. 2). Table 3 shows the values presented in graph form in FIG. 2 in tabular form.

TABLE 3
UZIN NC 172 BiTurbo made up with water (25% by weight of
water based on the total weight of the dry composition)

| t [h] | Total mass [g] | Colour change | Comment |
|---|---|---|---|
| 0 | 300.0 | Green | |
| 1 | 292.6 | Colour change to | Readiness for covering |
| | | reddish | attained |
| 2 | 283.7 | | |
| 3 | 278.8 | | |
| 5 | 276.3 | | |
| 21 | 268.9 | | |
| 26 | 267.3 | | |
| 48 | 266.0 | | |

A significant difference between the readiness for covering indicated by the levelling composition according to the invention and drying is therefore observed. The readiness for covering, indicated by the colour change, occurred after only about 1 hour, while actual drying (complete loss of water) continued at least to the next day (48 hours).

In the case of the systems described hitherto in the prior art, the colour change merely indicates that the respective products have been dried completely; in contrast thereto, the colour change in the case of the present invention indicates that the product is ready to be covered in the sense that damage-free adhesive bonding is possible.

In the case of Uzin NC 172 BiTurbo, the readiness for covering determined by the above-described method is attained at about 1 hour; the colour change with fluorescein is indicated at 1 hour, i.e. in the correct period of time. Evidence for the readiness for covering after 1 hour according to the definition (peeling value>0.6 N/mm after 24 hours after adhesive bonding and >1.0 N/mm after 4 days after adhesive bonding) was thus provided when using Uzin NC 172 BiTurbo. The peeling values were 1.1 N/mm after 24 hours after adhesive bonding and 2.1 N/mm after 4 days. Damage-free adhesive bonding is therefore ensured.

### Uzin NC 112 Turbo

In a further test, the readiness for covering of Uzin NC 112 Turbo was examined. The levelling composition likewise contains fluorescein (see above).

The loss of water from the levelling composition made up with water and applied to the substrate was examined as a function of time (see also FIG. 3). Table 4 shows the values presented in graph form in FIG. 3 in tabular form.

TABLE 4
UZIN NC 112 Turbo made up with water (19% by weight
of water based on the total weight of the dry composition)

| t [h] | Total mass [g] | Colour change | Comment |
|---|---|---|---|
| 0 | 300.0 | Green | |
| 1 | 296.1 | | |
| 2 | 290.0 | | |
| 3 | 286.6 | | |
| 4 | 283.7 | | |
| 5 | 281.8 | | |
| 6 | 281.0 | Colour change to | Readiness for covering |
| | | reddish | attained |
| 22 | 277.4 | | |
| 24 | 277.2 | | |

A colour change with fluorescein is also to be seen when using Uzin NC 112 Turbo; the change here occurs somewhat later than, for example, in the case of Uzin NC 172 BiTurbo, i.e. at about 6 hours. Here too, there is a significant difference between the point in time of readiness for covering (t₁=about 6 hours) and complete drying (t₂=about 25 hours).

### C Experiments Using Alternative Colour Indicators

The alternative colour change indicators bromothymol blue, thymol blue and phenolphthalein were tested in the gypsum system Uzin NC 112 Turbo.

Thymol blue is not sufficiently soluble in the aqueous alkaline systems used here. Phenolphthalein is readily soluble but is decolourized after only 1 hour, while the readiness for covering of the gypsum system Uzin NC 112 Turbo is attained at 6 hours. Phenolphthalein therefore proved to be unsuitable as indicator of the readiness for covering. In the same test, fluorescein displayed the same colour after 1 hour as at the beginning of the test, i.e. no colour change occurred before readiness for covering had been attained.

TABLE 5

| | | | | Colour | |
|---|---|---|---|---|---|
| | | | | 6 hours after | |
| | | | | application | |
| | | | Colour | (=point in time of the | Colour |
| | | Colour at the time of | 1 hour after | readiness for covering | 20 hours after |
| | | application of the | application of the | determined by the above- | application of the |
| Product | Colour indicator | levelling composition | levelling composition | described method) | levelling composition |
| UZIN NC | Fluorescein | Green | Green | Reddish | Reddish |
| 112 Turbo | Bromothymol blue | Blue (isolated dots) | Blue (isolated dots) | Blue (isolated dots) | Blue (isolated dots) |
| | Phenolphthalein | Pink | White | White | White |
| | Thymol blue | Blue dots | Blue dots | Blue dots/brown | Blue dots/brown |
| | | (inhomogeneous | (inhomogeneous | (inhomogeneous | (inhomogeneous |
| | | because of insolubility) | because of insolubility) | because of insolubility) | because of insolubility) |

Fluorescein was accordingly the only colour indicator which could reliably indicate readiness for covering.

### Summary of the Experiments

The difference between the point in time when the levelling composition is ready to be covered, which is indicated by fluorescein, and complete drying of the levelling composition could be shown. Fluorescein functions as colour indicator for the readiness for covering both in the case of gypsum levelling compositions and in the case of cement-containing levelling compositions. The indicators described hitherto in the prior art do not effectively indicate the readiness for covering.

What is claimed is:

1. A floor levelling composition which can be mixed with water and comprises fluorescein or a derivative thereof.

2. The floor levelling composition which can be mixed with water according to claim 1, wherein the derivative is selected from among eosin and/or uranin.

3. The floor levelling composition which can be mixed with water according to claim 1, wherein the fluorescein/fluorescein derivative is present in an amount sufficient for determining the readiness for covering.

4. The floor levelling composition which can be mixed with water according to claim 3, wherein the fluorescein/fluorescein derivative is present in an amount of 0.001-5.0% by weight based on the total weight of the dry composition.

5. The floor levelling composition which can be mixed with water according to claim 3, wherein the fluorescein/fluorescein derivative is present in an amount of 0.006-1.0% by weight based on the total weight of the dry composition.

6. The floor levelling composition which can be mixed with water according to claim 3, wherein the fluorescein/fluorescein derivative is present in an amount of 0.01-0.5% by weight based on the total weight of the dry composition.

7. The floor levelling composition which can be mixed with water according to claim 1, which is a cement-based or calcium sulphate-based floor levelling composition.

8. The floor levelling composition which can be mixed with water according to claim 1, which as ready-to-use composition has an alkaline pH in the range pH 8-14.

9. The floor levelling composition which can be mixed with water according to claim 8, which as ready-to-use composition has an alkaline pH in the range pH 9-12.

10. The floor levelling composition which can be mixed with water according to claim 1, comprising water in an amount of 10-60% by weight based on the total weight of the dry composition.

11. Use of fluorescein or fluorescein derivatives as an indicator for the readiness for covering of a floor levelling composition according to claim 10 which has been mixed with water.
